(19) United States
(12) Patent Application Publication
(10) Pub. No.: US 2001/0030173 A1
(43) Pub. Date: Oct. 18, 2001

(54) Contact arc-quenching system for power switchgear

(76) Inventor: Eduard Ulanovsky, Haifa (IL)

Correspondence Address: Eduard Ulanovsky, 45/2 Haviva Rike st., Haifa, 32541, IL

(21) Appl. No.: 09/757,092

(22) Filed: Jan. 10, 2001

Related U.S. Application Data
(60) Provisional application No. 60/176,730, filed on Jan. 20, 2000.

(51) Int. Cl. H01H 33/18

(52) U.S. Cl. 218/22

(57) ABSTRACT

Contact arc-quenching system (CAQS) of power switchgear (PSG) for application in contactors, current non-limiting automatic switches, contactor-automatic switches (air, vacuum or filled with gas, e.g., SF₆.)

In one basic embodiment CAQS has concentric contacts, round stationary contact 2, a circular moving contact 4 is positioned moving in radial plane; both contacts are placed into an insulation body 1 outside which constant magnets 8₁, 8₂ embraced by a clamp 9 of ferro-magnetic material are positioned on the axis of a constant magnet.

In another basic embodiment CAQS constant magnets are positioned inside cylindrical contacts, and contact surface of every contact has the shape of a ring (elongated ring) in the rotating body(cylinder) butt end, and both contact surfaces are symmetrical relative to each other.

There exist modifications with a contact bridge formed by moving contacts, with positioning of the constant magnet in a cartridge of ferro-magnetic material, with saddle-like constant magnet outside contacts, with current conducting soldered bosses of increased conductivity on contact surfaces.

### BACKGROUND OF THE INVENTION

The invention relates to the field of electrical engineering and to arc-quenching contact systems for power switchgears in particular, and can be used in manufacture of contactors, automatic current non-limiting switches and contactors -automatic switches.

The existing low-voltage contact arc-quenching systems for power switchgears include, as a rule, contact systems with spring-loaded contacts and arc-extinguishing chamber.

In a.c. current non-limiting switchgears the arc is quenched during the natural passage of current through zero.

It is necessary to note that in low-voltage a.c.electrical devices (U_{H}≦66OV) repeated arc ignition after its natural quenching with current passage through “O” can be prevented in the following way: by elongating the arc up to a critical value L_{c}, so that after the natural arc quenching as the result of the arc stem deionizing, its resistance becomes so high that repeated breakdown would be impossible;

by creating conditions when at the moment of the natural arc quenching the temperature of its bases (contact spots on contact parts) would be relatively low (in any case considerably lower than the melting temperature of contact parts material).

In this case so called “instantaneous restoring strength” appears attaining the value of 200 . . . 250V. This value is sufficient for preventing repeated breakdown with nominal voltage per one gap equal U_{H}≦3800V even if the arc stem is 3-4 mm; long.

To meet this condition it is necessary that the arc moves with such a speed that it doesn't have time for contact parts heating (i.e. the contact parts are to remain “cold”).

Arc displacement can be provided for by the action of a strong magnetic field and corresponding design of the contact parts.

Only the first method of repeated breakdown protection—arc elongation—is used in modem low-voltage devices.

The second method—rapid arc displacement—is rather often applied in high voltage devices but not with the aim of using “instantaneous restoring strength” (as 200-250 V cannot influence the deionizing process in intercontact gap with devices' nominal voltage of several tens kV and higher). In high voltage devices rapid movement of long arc is used for cooling its stem (with the aim of its cooling intensification).

Blowing of the arc by compressed air or by SF₆ gas is also often used for the same purpose.

Thus, in modem low- and high-voltage a.c. devices prevention of repeated breakdowns after natural arc quenching is carried out exclusively by exerting action on arc stem.

For certifying the above said, see e.g. Israeli patents No 19257 dated 1963, Int.Cl.HOlh 33/10; No 40438 dated 1971 (priority from Switzerland), Int.Cl.HOlh 33/10. 73/18; No 41451 dated 1972 (priority from Germany), Int.Cl.HOlh 85/38; No 47253 dated 1974 (priority from Germany), Int.Cl.HOlh 9/36, 33/04, 33/10, 73/18; U.S. Pat. No. 586,445,3, published Jan. 26, 1999, US Cl.361-14, Int.Cl.HOIH 73/00; ; U.S. Pat. No. 557,919,8, dated 1996 in the same classes.

In low-voltage direct current (d.c.) switchgears the arc is quenched, first of all, by arc elongation (i.e. increase in circuit resistance), with arc voltage surpassing the feeding voltage of the switchgear.

Together with definite advantages for definite application cases, all the known devices mentioned possess to a certain extent specific disadvantages: considerable size and weight (and, correspondingly, high cost), insufficient reliability of quenching, relative complexity in arc quenching systems design.

Within the framework of approach to solving the problem studied by means of magnets blowing out the arc (see, e.g. A. A. Chunichin and M. A. Zhavoronkov “High-voltages devices”, Moscow, Energo-atomizdat, 1985), two main types of arc quenching devices (systems) are being known causing the phenomenon of a “running” arc used in high-voltage devices and to a sufficient degree meeting the tendencies in arc-quenching means development:

devices where the arc displaces (rotates, “runs”) radially in relation to the chamber axis (between cylindrical surfaces of concentric contacts—moving and stationary), and

devices where the arc displaces (“runs”) along the butt ends circumference of cylindrical contacts (moving and stationary).

Arc-quenching system for the 1^{st} device with a “running” arc (see FIG. 1 in Appendix to the description) includes a moving cylindrical contact 1 and stationary outer circular contact 2 whereon a magnetic blow-out coil (winding) 3 is positioned. As seen from FIG. 1 lines of force of the magnetic field created by magnetic blow-out winding in the gap between inner and outer contacts run parallel to the chamber axis and, correspondingly, perpendicular to the axis of the arc burning between two contacts.

This system is simple and sufficiently cheap. The system is used in high-voltage power isolators and high-voltage switches with low interrupting capacity.

Arc-quenching system of the 2^{nd} device with a “running” arc (see FIG.2 in the Appendix mentioned) includes moving 1 and stationary 2 circular contacts whereon magnetic blow-out windings 3, 4 are positioned.

As seen from the FIG. 2 an arc is burning between the contact butt ends 1 and 2. As lines of force of magnetic field created by magnetic blow-out windings 3, 4 are perpendicular to the arc axis, the arc is rotating (“running”) along the contact butt ends 1 and 2 (along the periphery of contact rings).

This system of magnetic blow-out is sufficiently effective but relatively expensive, it is large in size and complex especially in the part of controlling the magnetic blow-out windings feeding. It is used in power isolators and high-voltage switches.

The aim of the present invention applying the phenomenon of “instantaneous electric strength” consists in creating a relatively simple arc-quenching contact a.c. system, which is small in size, low in weight and cheap as well as possessing increased reliability and cyclic stability (longevity) together with the principal possibility of application in installations with low-voltage d.c. and relatively small high-voltage a.c.

### SUMMARY OF THE INVENTION

The goal set forth is attained by means of the arc-quenching contact system proposed for power switchgear having concentric contacts where:

stationary contact is made in the shape of a disk, with the axis forming current outlet of this contact;

circular moving contact is positioned round the stationary one moving in radial plane, and its axis is parallel to the axis of the stationary contact forming current outlet of the moving contact;

both contacts mentioned are positioned in the insulator body,

whereas outside it on a stationary contact axis, stationary magnets are positioned embraced by a ferromagnetic clamp which forms an outer magnetic circuit,

together with the said magnets creating the magnetic field, lines of force of this magnetic field are directed parallel to the

longitudinal axis of the contacts mentioned, and in the gap between the contacts the lines of force are directed perpendicular to the arc axis, with the arc appearing with contacts breaking, thus causing the arc rotation round the stationary contact.

For relatively weak-current contacts presence of the outer magnetic circuit is not obligatory.

As a rule

working surfaces of the system contacts have arc-resistant current conducting soldered pieces (bosses) of increased conductivity along which current is running when the contact system is closed, with outer surface of each soldered boss made flush with the said working surfaces.

This provides for formation of smooth (without contact bosses) tracks for rapid movement of the arc and preservation of “low” temperature of contact surfaces.

In one of the modifications the system has two moving contacts positioned on one axis representing constructively a kind of a bridge contact and forming a contact bridge with two stationary contacts. Current outlets are connected with stationary contacts. Pressing of the contact is effectuated by, e.g., a spring-loaded link connected to the drive.

Modification of the basic variant of the system is also being provided for where saddle-shaped constant magnets with pole pieces made of ferromagnetic material can be used instead of ring (disk) magnets.

In another basic embodiment of the contact arc-quenching system of the switchgear mentioned;

constant magnet is positioned inside each stationary contact with outlets,

and the contact surface is made in the shape of a ring (elongated ring) in the cylinder (rotating body) butt end, with insulating arc-resistant insert positioned inside the butt end,

moving contacts form a contact bridge, and a constant magnet are also positioned in each moving contact,

hereby contact surface of the moving contact is made in the shape of a ring (elongated ring) in the butt end of the rotating body (cylinder) symmetrically positioned in relation to the contact surface of the stationary contacts with an insulating arc-resistant insert positioned in it and symmetrical to the stationary contact insert,

wherein each pair of the said magnets in each pair of stationary and moving contacts creates magnetic field,

lines of force of the said magnetic field in the gap between each contacts pair are directed perpendicularly to the arc axis appearing with contacts breaking, thus causing arc rotation in the said gap of the corresponding pair of contacts.

In one of the modifications of the 2^{nd} basic variant the system of the each of two stationary contacts is embraced by a cup-like magnetic circuit, and stationary contacts forming the contact bridge are made without constant magnets.

In the optimum embodiment of the second basic variant of the system, current-conducting soldered bosses of increased conductivity are also positioned flush with the contact butt ends, thus providing relatively low temperature of the contact surfaces.

In one more modification of the 2^{nd} basic variant the system inside the stationary and ordinary moving spring-loaded contacts constant magnets are positioned. Contact surface of each contact is shaped as a ring (elongated ring) in the butt end of the rotating body (cylinder), inside which (butt end) an insulating arc-resistant insert is positioned flush with the surface if the contact. In this case contact surfaces of the contacts are situated symmetrically in relation to each other. The said magnets as well as in other modifications, create a magnetic field with lines of force in contact gap being directed perpendicular to the arc axis causing its rotation. Constant magnets can be positioned in a cup-like magnetic circuit which in its turn may be positioned inside or outside the contact.

Hereby the proposed system in any of the its variants of embodiment and modifications can exist in the atmosphere or be placed into the gas SF₆ medium or in vacuum.

And, finally, the system in any of the variants as applied to a.c.current power switchgear can be made of m-phase (where m≧3), three-phase in particular.

### BRIEF DESCRIPTION OF THE DRAWINGS

The essence of the invention is explained by the drawings where:

FIG. 1 is a variant of contact arc-quenching system on the basis of concentric contacts (a, b—closed and disconnected contact positions correspondingly).

FIG. 2 the same with the two stationary contacts and contact bridge (a—longitudinal section, b, c 13 closed and disconnected position of the contacts correspondingly).

FIG. 3 system variant with a moving part on the basis of a bridge contact and constant magnets in all the contacts (a and b—closed and disconnected contacts position correspondingly).

FIG. 4 the same with constant magnets in stationary contacts.

FIG. 5 system fragment with one stationary and ordinary moving contact and flat working surface of each contact (a and b—closed and disconnected contacts position correspondingly).

FIG. 6 the same but with constant magnets embraced by cup-like magnetic circuits (a and b—with magnetic circuits positioning correspondingly inside and outside the contacts).

FIG. 7 diagrammatical representation of the 3-phase embodiment of the contact arc-quenching system as applicable to a.c. switchgear.

### DESCRIPTION OF THE PREFERRED EMBODIMENTS

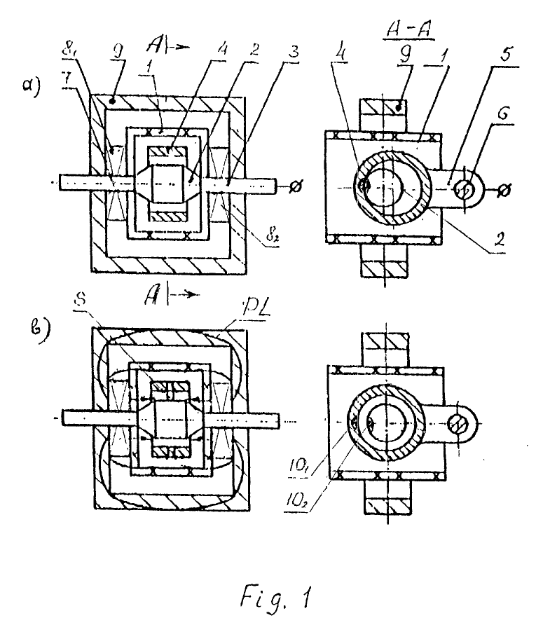

The device proposed in its 1st basic embodiment is made as following (FIG. 1).

In body 1 made of insulation material a stationary, e.g. copper, contact 2, cylindrical (circular in particular) in shape, is installed with axis also forming outlet 3 of this contact.

Circular moving spring-loaded contact 4 with radial outlet 5, kinematically connected with the drive by means of hole 6, in particular, is positioned round (outside) the stationary contact. Contact 4 is also placed in insulation body I (i.e. body made of insulation material).

Outside insulation body 1 on stationary contact axis 7 (including its part forming outlet 3) counter oriented stationary magnets 8₁ and 8₂ are situated. The latter are pressed to body 1 by closed clamp 9 made of a ferro-magnetic material forming outer magnetic circuit (which can be two-sided as shown in FIG. 1 as well as one-sided, i.e. represent the upper or lower part of position 9).

This magnetic circuit together with magnets 8₁ and 8₂ creates magnetic field, with its lines of force directed parallel to longitudinal axis 7 of contacts 2 and 4, and in the gap between these contacts are directed perpendicular to the axis of the arc (its conventional cross-section S being shown in FIG. 1b), which appears with disconnecting contacts 2 and 4, thus rotating the arc round the stationary contact 2.

Working surfaces of contacts 2 and 4 are fitted with current-conducting soldered bossed 10₁ and 10₂ having increased conductivity, with outer surface of each boss being made flush with the said working surfaces of contacts 2 and 4, thus providing for the formation of smooth tracks for displacing the arc which appears with contacts breaking, and, correspondingly, decreasing electrical wear of the contacts.

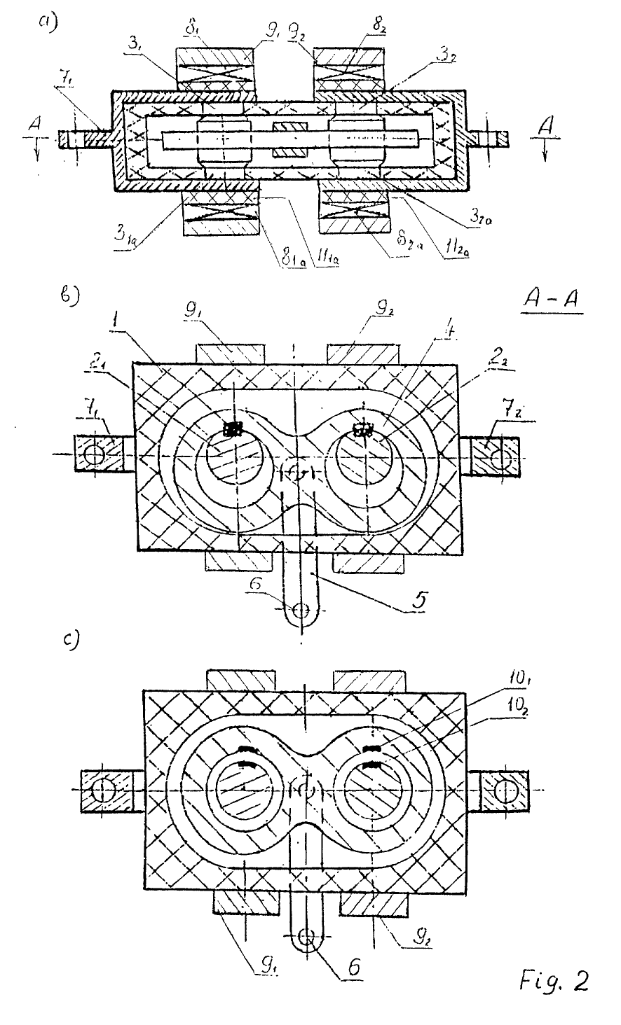

One of the system modifications (FIG. 2) has two moving contacts positioned on one axis constructively representing a contact bridge and forming a bridge contact 4 with two stationary contacts 2₁ and 2₂.

The said contact bridge 4 is connected to the drive, e.g. by a spring loaded link 5 by means of hole 6.

Outside the insulation body 1 current-conducting outlets 7₁ and 7₂ are positioned, being electrically and mechanically (e.g. by soldering) connected to current outlets 3₁, 3₁ₐ, 3₂, 3₂ₐ of stationary contacts 2₁ and 2₂ representing axes of these contacts.

Outside outlets 7₁, 7₂ perpendicular to axes (outlets) 3₁, 3₂ counter-oriented constant magnets 8₁, 8₂ are being fixed. The latter are clamped to outlets 7₁, 7₂ by clamps 9₁, 9₂ made of ferromagnetic material and forming two outer magnetic circuits which together with magnets create two magnetic fields. Lines of force of these fields are directed parallel to axes 3₁, 3₂ of the contacts 2₁, 2₂.

Lines of force in the fields mentioned in the gaps between contacts 2₁, 2₂ and 4 are directed perpendicular to the arc axes appearing with disconnecting these contacts, thus causing arc rotation round stationary contacts 2₁, 2₂ (analogous to the basic variant described).

Working surfaces of contacts 2₁, 2₂ and 4 are fitted with current-conducting soldered bosses 10₁, 10₂ of increased conductivity and of the shape described above and with the same purpose.

In other words, in this modification of the basic variant for the proposed contact arc-quenching system of the power switchgear:

stationary contacts are made in a shape of a cylinder with a relatively low height (in relation to diameter) with current outlets in the form of axes.

moving contact is a bridge one connected to a spring-loaded link.

contacts interaction in the switched-in position is provided via arc-resistant contacts soldered bossed of increased conductivity,

current outlets are mechanically and electrically connected to current outlets of stationary contacts,

magnetic fields in gaps between the contacts are created by means of constant magnets and a clamp made of ferromagnetic material (there are two constant magnets and one clamp per each gap),

lines of force of these fields are directed perpendicular to the arc axes causing their rotation round stationary contacts.

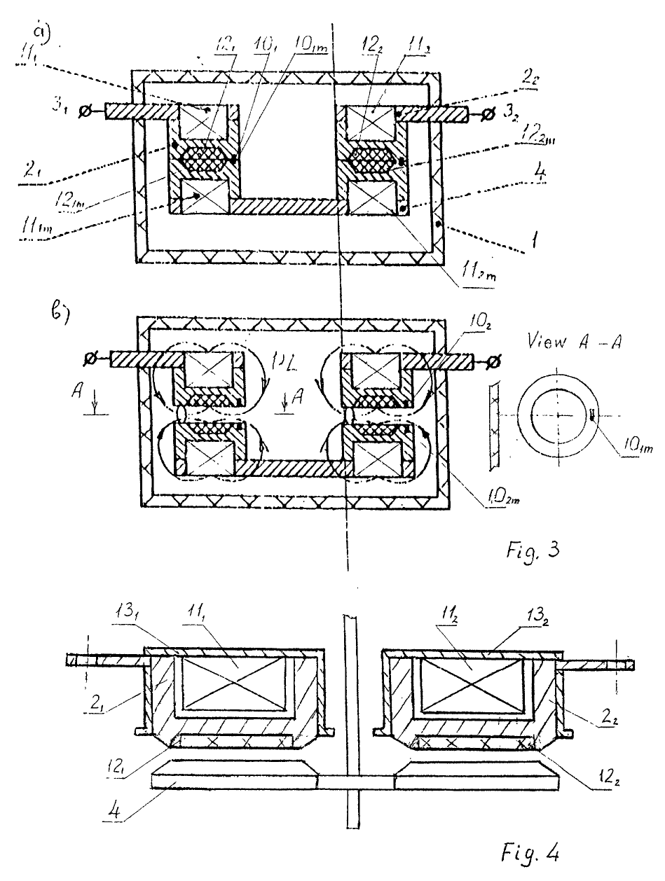

The proposed device in its 2^{nd} basic embodiment (FIG. 3) also consists of insulation body 1, but contact arc-quenching system of power switchgear is wholly positioned inside the body.

Two stationary circular contacts 2₁ and 2₂ with outlets 3₁ and 3₂ are fixed in the body.

Corresponding moving contacts are constructively represented by spring-loaded bridge contact 4.

Inside each stationary contact 2₁ and 2₂ constant magnet 11 (correspondingly 11₁, and 11₂ ) are situated, and contact surface of each—contact 2₁ and 2₂ has the shape of a ring in the cylinder butt end (or an elongated ring in the rotating body butt end), inside which an insulating arc-resistant insert 12₁, (correspondingly 12₂)is positioned.

Each moving contact in bridge contact 4 is made analogous to the stationary one, i.e. constant magnets 11₁ₘ and 11₂ₘ are positioned in each moving contacts; hereby contact surface of each moving contact is made in the form of a ring (or elongated ring) symmetrically positioned relative to contact surface of stationary contact. Inside contact surface of each moving contact insulation insert 12₁ₘ (12₂ₘ), symmetrical insert 12₁, (12₂) of the stationary contact are positioned.

Each pair of the said magnets 11₁, 11₁ₘ (11₂, 11₂ₘ) of each pair of stationary 2₁ (2₂) and moving 4 contacts is destined for creating the magnetic field with lines of force PL in the gap of each said pair of contacts 2₁, 4 (2₂, 4) are directed perpendicular to the axis of the arc appearing with contacts breaking, thus rotating the arc in the said gap of a pair of corresponding contacts 2₁, 4 (2₂, 4).

In other words, in the 2nd basic embodiment of the contact arc-quenching switchgear:

the contacts have the form of a cylinder with a relatively small (if compared to its diameter) height,

contact surface where contacting occurs, as well as rapid arc displacement with breaking is represented by the cylinder butt end surface,

on the side of contact butt end, contact cylinder is closed by an arc-resistant insulation gasket (greater part of the butt end surface),

moving and stationary contact are situated on one axis,

constant magnet is positioned inside the cylinder,

lines of force of magnetic fields formed by magnets of stationary and moving contacts are directed counter each other, as the result in the zone of contact butt ends, the field is directed radially, and consequently perpendicular to the arc appearing with contacts breaking ( which makes the arc to rotate rapidly on contacts butt ends leaving them cold),

contacts contacting in position “switched in” is carried through arc-resistant contact bosses (of increased conductivity) 10₁, 10₁ₘ, 10₂, 10₂ₘ.

It is possible to position bosses just on the butt ends for relatively weak-current devices as in this case with every turn of the arc its bases go through the bosses.

It is possible to displace the bosses from the butt end to the cylinder axis. The arc, in this case, will bypass the boss when moving which is important for high-current devices.

In one of the modifications (FIG. 4) of the 2nd basic variant each of the two stationary contacts is embraced by a cup-like magnetic core 13₁, 13₂, whereas moving contacts forming contact bridge 4 in particular, are manufactured without constant magnets (other designations of elements further on naturally correspond to the elements mentioned above and performing the same function).

Yet, in one more modification of the 2nd basic embodiment the system is fitted with one moving spring-loaded contacts 4 (FIG. 5) with outlet 3ₘ and stationary contact 2 with outlet 3.

As in the 2nd basic variant mentioned, contact surfaces of contacts 2 and 4 are in the shape of rings in cylinder butt end with insulation inserts 12 and 12ₘ positioned inside them. Constant magnets 11 and 11ₘ are positioned inside contacts and counter-oriented. These magnets, as in the basic variant mentioned, create magnetic field with lines of force PL in the gap between contacts 2 and 4 directed perpendicular to the axis of the arc occurring with their disconnection, thus rotating the arc in the gap mentioned.

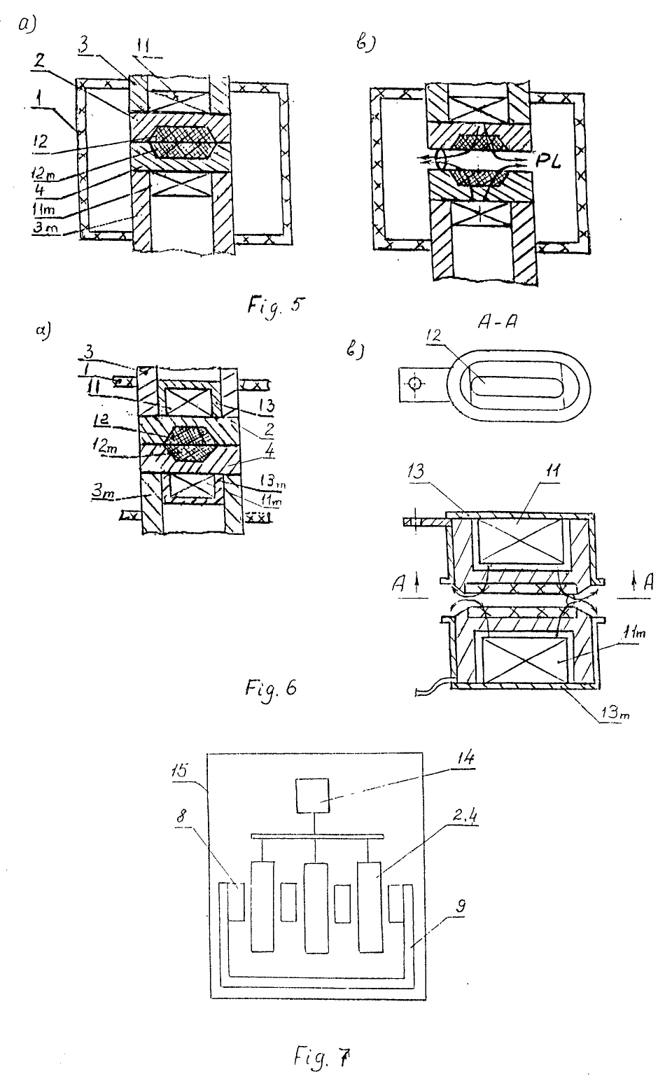

Also, in one more modification the system (FIG. 6) is analogous to the previous one (FIG. 5), but constant magnets of contacts 2 and 4 are positioned in cartridges 13 and 13ₘ made of ferro-magnetic material, with each of them forming cup-like magnetic circuit. Cartridges can be placed inside contacts 2 and 4 (FIG. 6a), as well as outside these contacts (FIG. 6b).

This permits to decrease magnetic resistance to the flow.

At last, a modification of the 1st basic variant of the system is provided for where, instead of ring-shape (disk) magnets, saddle-like constant magnets with, pole parts of ferro-magnetic material can be positioned outside the contacts.

The contact arc-quenching system proposed in both basic embodiments can be positioned in vacuum or in gas SF₆ medium for improving the conditions of arc quenching.

3-pole system variant shown in FIG. 7 includes 3 pole of any modification. Poles can form m-phases (where m≦3) or may be connected in series forming one phase.

Hereby in the 1^{st} basic variant, in particular, the system is to possess three contact systems (FIG. 7) where constant magnets 8 are positioned between them as well as outside the bordering systems, the said magnets being situated in conformity with each other; thus, contact systems with contacts 2, 4 on the side opposite to drive 14 are embraced by a constant magnetic circuit 9 (with weak currents magnetic core can be eliminated).

The whole structure is situated in a common body 15.

Hereby, as follows from the above said, in the 2^{nd} basic variant any contact, constant magnet and cup-like magnetic circuit can be round or oval in their cross-section. Here, it is to be taken into account that constant magnet and magnetic circuit can be installed only on a stationary contact (for low voltage switchgear) or on stationary and moving contacts (for high voltage devices)

The device in the 1^{st} basic embodiment operates in the following way:

In the switched-in position (FIG. 1a, cross-section A-A) moving contact 4 is pressed to stationary contact 2. Touching occurs on the outer surface of contact 2 and inner surface of contact 4. Current flows along the outlet 3, stationary contact 2, moving contact 4 and outlet 5.

When switching-off (FIG. 1b) moving contact 4 is displaced under the action of, e.g., electric magnetic drive. Short arc appears between contacts 2 and 4 (length 1ₑₐ≦5 mm). Lines of force PL of magnetic field created by constant magnets 8₁ and 8₂ and outer magnetic circuit (clamp 9), in the gap between the inner contact surface 4 and outer surface of contact 2 are directed (as it has been mentioned above) parallel to the arc-quenching chamber axis and, correspondingly, perpendicular to axis of the arc causing its rotation.

As applied to the a.c. power contact arc-quenching switchgear, the arc is quenched with current naturally passes over zero.

As applied to the d.c. contact device (feed voltage 24V) arc quenching is provided for during its elongation (contacts divergence) up to the length of 2 mm.

Temperature of contact materials heating is inversely proportional to electromagnetic induction.

With creation of the necessary induction, temperature for contacts heating can be lower than the temperature of their melting, thus meeting the requirements of longer cycle stability and high characteristics of arc quenching.

Device operation according to the 1^{st} basic embodiment (but with bridge contacts) occurs in the following way:

In switched-in position (FIG. 2a) moving bridge contact 4 is pressed against stationary contacts 2₁ and 2₂ by spring-loaded link 5. Touching occurs along the inner surface of contact 4 and outer surfaces of contacts 2₁ and 2₂ via arc-resistant soldered bosses 10₁ and 10₂ with increased conductivity. Current flows along current lead 7₁, current outlet 3, stationary contact 2₁, moving contact 4, stationary contact 2₂, current outlet 3₂ , current lead 7₂.

With switching-off (FIG. 2b) contact 4 is moved under the action of, e.g., electromagnetic drive.

Short arc (l_{arc}≦5 mm) ignites between contacts 2₁, 2₂ and 4. Lines of force PL of magnetic field created by pairs of constant magnets 8₁ and 8₂ and outer magnetic circuit 9₁ and 9₂ (or without them in their absence) in the gap between contacts 2₁, 2₂, and 4 are directed (as it has been mentioned above) perpendicular to the axis of the arcs causing their rotation in these gaps.

As applied to the a.c. power contact arc-quenching switchgear, the arc is quenched in the first half-period with current natural pass over zero.

As applied to the d.c. switchgear the arc is quenched with its elongation (contacts divergence) for the length necessary for the given voltage.

Device operation according to the 2^{nd} basic embodiment occurs in the following way:

In switched-in position (FIG. 3) spring-loaded contact bridge 4 is pressed against the stationary contacts 2₁ and 2₂. Touching occurs along the circular surfaces of contacts. Current flows along outlet 3, contacts 2₁, 4, 2₂, outlet 3₂.

With switching-off (FIG. 3b) moving contact 4 is moved under the action of a drive, e.g., electric magnet.

Short arc (length lₑₐ≦5 mm) ignites between circular surfaces of contacts 2₁, 4 and 2₂, 4. Lines of force PL of magnetic field created by constant magnets 11₁, 11₁ₘ and 11₂, 11₂ₘ in the gap, between contacts 2₁, 4 and 2₂, 4 are directed (as it has been mentioned above) perpendicular to the axis of the arc causing its rotation.

As applied to the a.c. power contact arc-quenching switchgear, the arc is quenched in the first half-period with current natural pass over zero.

As applied to the d.c. contact device (feed voltage 24V) the arc is quenched with its elongation up to the 2 mm.

Temperature for contacts heating (with the same current) connected with electromagnetic induction (as mentioned above) can be lower than the temperature of their melting, thus meeting the requirements of longer cycle stability and high characteristics of arc quenching (as in the 1^{st} basic embodiment):

From the above said it follows that the device proposed is novel useful and is characterized by a solution non-evident for the specialists, its main embodiments are united by the general idea of the invention, and thus deserve legal protection in the form of a single patent.

I claim:

1. A contact arc-quenching system for power switchgear with concentric contacts characterized by that:
stationary contact made in the shape of disc with the axis also forming
current outlet of the said contact,
circular moving spring-loaded contacts with radial outlet positioned round (outside) the stationary contact an d connected with the drive,
both contacts positioned in an insulation body,
with constant magnets counter-positioned outside the body on the axis of the stationary contact and creating the magnetic field,
with lines of force directed parallel to the longitudinal axis of the said contacts and perpendicular to the arc axis appearing with contacts breaking and causing arc rotation round the stationary magnet.

2. The contact arc-quenching system as in claim 1, wherein:
contacts are made strong-current, and
constant magnets are embraced by a ferro-magnetic material clamp forming an outer magnetic circuit, together with the said magnets creating the magnetic field, with lines of force directed parallel to the longitudinal axis of the said contacts and perpendicular to the arc axis in the gap between contacts during contacts breaking.

3. The contact arc-quenching system as in claim 1 or 2,
which is fitted with the second stationary contact and second moving circular contact,
hereby the latter is positioned on the same axis with the first moving contact,
forming together with it a contact bridge fitted with spring-loaded link connected to the drive.

4. A contact arc-quenching system of power switchgear, wherein:
saddle-like constant magnet, mainly with a pole part from ferr-magnetic material is positioned round each pair of stationary and moving contacts,
moving contacts form a contact bridge, and contact surface has the shape of a ring,
hereby each saddle-like magnet mentioned creates magnetic field with lines of force in the gap of every contact pair mentioned directed perpendicular to the arc axis occurring with contacts breaking causing its rotation round a stationary contact.

5. A contact arc-quenching system of power switchgear, wherein
a constant magnet (a disk one in particular) is positioned inside a stationary contact with outlet,
and contact surface is in the shape of a ring (elongated ring) in the cylinder (rotating body) butt end, inside which an insulation arc-resistant insert is being positioned,
a constant magnet is also positioned in the moving contact, hereby the contact surface of the moving contact is in the shape of a ring (elongated ring) in the cylinder (rotating body) butt end which is symmetrically positioned in relation to the contact surface of the stationary contact,
with an insulation arc-resistant insert positioned in the butt end, in particular flush with the surface of the insulation arc-resistant insert, symmetrically to the insert of the stationary contact,
hereby the magnets mentioned create the magnetic field, with the lines of force in the contact gap being directed perpendicular to the arc axis occuring with contacts breaking, thus causing arc rotation in the gap mentioned.

6. The contact arc-quenching system as in claim 5 wherein each constant magnet is positioned in a cup-like magnetic circuit.

7. The contact arc-quenching system as in claim 6, wherein each cup-like magnetic circuit is positioned outside the contact.

8. A contact arc-quenching system of power switchgear wherein
a constant magnet, a disk one in particular, is positioned inside each of the two stationary contacts with outlets,
and a contact surface is in the shape of a ring (elongated ring) in the cylinder (rotating body) butt end, inside which an insulation arc-resistant insert is being positioned,
moving contacts form a contact bridge, and a constant magnet is positioned in each moving contact,
hereby the contact surface of the moving contact is made in the shape of a ring in the cylinder(rotation body) butt end, symmetrically positioned in relation to contact surface of a stationary contact, with insulation arc-resistant insert being positioned in the butt end, in particular flush with the surface and symmetrical to the insert of a stationary contact,
hereby each pair of the said magnets in each pair of stationary and moving contacts creates a magnetic field,
with the lines o force in the gap of every contact pair mentioned directed perpendicular to the arc axis occuring with contact breaking causing arc rotation in the said gap of the corresponding pair of contacts.

9. A contact arc-quenching system of the power switchgear, wherein
each of the two stationary contacts a cup-like magnetic circuit,
inside each contact mentioned with outlets a constant magnet (e.g., a disk one) is being positioned,
and contact surface is in the shape of a ring (elongated ring) in the cylinder (rotation body) butt end
wherein an insulation arc-resistant insert is being installed,
moving contacts form a contact bridge,
hereby contact surface of a moving contact is made in the shape of a ring (elongated ring) in the cylinder (rotation body) butt end, symmetrically positioned in relation to the contact surface of a moving contact with positioning of an insulation arc-resistant insert inside the mentioned contact surface symmetrical to the insert of a stationary contact,
hereby, each of the said magnets with its cup-like magnetic circuit creates a magnetic field,
with the lines o force in the gap of every contact pair mentioned directed perpendicular to the arc axis occuring with contact breaking causing arc rotation in the said gap of the corresponding pair of contacts.

10. The contact arc-quenching system as in claim 9, wherein cup-like magnetic circuits are fixed outside the contacts.

11. The contact arc-quenching system as in any given claims 1-10, wherein:
working surfaces of contacts have current conducting soldered pieces of increased conductivity,
with each outer surface made flush with the said working surfaces of contacts, providing for formation of smooth tracks for displacement of the arc created and preservation of a relatively low temperature of contacts surfaces.

12. The contact arc-quenching system of power switchgear as in any given claims 1-11, which is made enclosed into the medium of gas SF₆.

13. The contact arc-quenching system of power switchgear as in any claims 1-11, which is positioned in vacuum.

14. The contact arc-quenching system as in any given claim 1-13, which in relation to any alternating current power switchgear is made as a m-phase one (where m≧3), three phase in particular.
